(19) United States
(12) Patent Application Publication
(10) Pub. No.: US 2004/0160670 A1
(43) Pub. Date: Aug. 19, 2004

(54) Device for creating and enhancing 3D images within transparent materials

(76) Inventor: Mario Joseph Magro, Beverly Hills, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/367,437

(22) Filed: Feb. 14, 2003

(51) Int. Cl. G02B 27/24

(52) U.S. Cl. 359/472; 428/156

(57) ABSTRACT

This invention relates to a device consisting of at least two layers of transparent or translucent rigid material fixed substantially co-planar with a hollow separation between them and with at least one having a pattern, image, or design on it. Light passing through one layer will hit the pattern, image, or design and transfer a shadow onto the second layer, creating the illusion of a three-dimensional (3D) or multi-dimensional pattern, image, or design on the interior of the device. A third opaque layer or backdrop may be added to increase the depth of the visual effect, or the effect may be decreased by using a solid layer without any texture to the pattern.

### REFERENCES CITED

US Patent Citations

| | | |
|---|---|---|
| U.S. Pat. No. 6,510,244 | Proesmans | Jan. 21, 2003 |
| U.S. Pat. No. 6,496,597 | Tampieri | Dec. 17, 2002 |
| U.S. Pat. No. 6,496,286 | Yamazaki | Dec. 17, 2002 |
| U.S. Pat. No. 6,262,842 | Ouderkirk | Jul. 17, 2001 |
| U.S. Pat. No. 6,213,616 | Chien | Apr. 10, 2001 |
| U.S. Pat. No. 4,791,533 | Hane | Dec. 13, 1988 |
| U.S. Pat. No. 5,668,913 | Tai | Sep. 16, 1997 |
| U.S. Pat. No. 5,175,967 | Greenwood | Jan. 5, 1993 |

### BACKGROUND OF THE INVENTION

1. Field of the Invention

This invention relates to a device that uses light, whether natural sunlight, ambient room light, or artificial and directed light, to create shadows on an inner surface of the device, creating the illusion of a three-dimensional (3D) or multi-dimensional figure or pattern in the interior of the device. Such visual patterns are observable from outside the device.

2. Description of Related Prior Art

Surfaces have long been decorated with patterns on the exterior. Exterior ornamentation is applied to the hard surface of thousands of products, from furniture to floors to shower doors. These patterns are most often directly applied onto the exterior surface, for instance by painting, drawing, stamping, heat transfer, or glue. Occasionally, the patterns have three-dimensional (3D) character created by a means that raises the pattern above the surface or cuts into it, such as by embossing or engraving.

Exterior surface ornamentation is often damaged or entirely lost over time. Paint or ink will scratch or wash off, heat transfers will unpeel, glue will dissolve. All of these exterior applications are subjected to destructive chemicals and forces that come into contact with them. In addition, the application of ornamentation to the exterior surface renders it uneven, and if a 3D effect is added, the surface can be significantly irregular.

Patterns and ornamentation have also been imbedded or otherwise placed within transparent materials, such as by molding techniques in which decorative elements are added while the materials are in a liquid state before cooling and solidifying, or by adding decorative elements between several layers of transparent materials that are then glued or otherwise secured together.

U.S. Pat. No. 6,213,616 shows designs and messages of electroluminescent elements applied on or within the walls of containers.

The effects of passing light through various types of materials and then reflecting or distributing it has been the subject of much prior art. U.S. Pat. Nos. 5,175,967, 4,706,649, and 3,246,564 teach devices that distribute natural light from the exterior of a dwelling into the interior. U.S. Pat. No. 4,791,533 shows a device that uses a rotating mirror to reflect natural light as it moves relative to the device. U.S. Pat. No. 5,668,913 is for a light system that converts a light beam generated from a point-like light source into a collimated linear or planar light beam. U.S. Pat. Nos. 5,668,913 and 6,262,842 teach lighting systems for liquid crystal displays using reflective devices.

### SUMMARY OF THE INVENTION

In the present invention, 3D and multi-dimensional visual effects are created on a surface that is internal to the exterior of the device by means of shadows caused when light hits a patterned layer within the device. The device consists of two or more panels of transparent or translucent materials fixed substantially parallel to each other with a hollow space between them. At least one of the panels has a pattern on (or in) its surface. When light, whether natural sunlight, ambient room light, or artificial and directed light, passes through the exterior surface of the transparent panel of material and shines upon the patterns cut into (or placed upon) the interior surface of that same sheet, the light creates shadows on the surface of the patterned panel. To increase the depth of the image, a third opaque panel or backdrop may be placed at a distance behind the patterned panel, in which case a second shadow will be appear on this third panel when the light passes through the first two panels. The size of the shadows will vary depending on the distance between the panels. The shadows give the image or pattern the illusion of being 3D or multi-dimensional.

The present invention offers an innovative way to make 3D and multi-dimensional decoration and patterns that are not applied to the exterior surface. Examples of such products include mugs, bottles, vases, ladies' fashion purses, shoes, hats, table tops, shower doors, cabinet doors, and windows, although the range of items is virtually unlimited. Many such items are decorated, and the addition of inlaid and surface protruding stones, rhinestones, and even lighted stones have become popular.

This invention allows for 3D and multi-dimensional ornamentation without any application to the exterior surface of the transparent material. The pattern is internal, within the hollow core of the device, and therefore protected from destruction caused by contact with exterior chemicals or forces. The light is not reflected, refracted, or distributed by any complex methods, but the shadows cast when the light shines on the patterns create the illusion of depth, and therefore this device is relatively easy and cost-efficient to reproduce. An added advantage of this invention is that the layers have hollow space between them, making the invention light in weight.

### BRIEF DESCRIPTION OF THE DRAWINGS

FIG. 1 depicts a device as contemplated in this invention from a side view.

FIG. 2 shows some of the many different orientations of the pattern plates possible in this invention. These are again observed from the side.

FIG. 3 demonstrates a particular device as contemplated by this invention, specifically, a lady's fashion purse. The purse is shown in partial frontal view 3A, and also in side view (in two variants, 3B and 3C).

FIG. 4 illustrates the same particular embodiment of the current invention as in 3A. In this figure, the purse is shown in a cutaway side view. In this case, exterior layer 1 and interior layer 2 are transparent and unadorned, while layer 3 is both patterned and opaque. In other versions of the purse, interior layer 2 is patterned, though still transparent, while opaque layer 3 is unadorned with patterns. Ambient light from outside enters through 1, then 2, and reflecting on opaque layer 3.

FIG. 5 shows a different embodiment of the current invention, in which the light source is located behind the pattern plate. This figure also demonstrates the use of a backdrop as part of the device. the current invention with the use of reverse lighting.

### DETAILED DESCRIPTION OF THE DRAWINGS

The present invention is of a class of devices that exhibits 3D and multi-dimensional images within the core of transparent materials incorporated in the devices. The devices comprise at least one surface, or exterior, transparent layer and at least one patterned layer, as well as an optional opaque layer or backdrop. The layers are set apart, and the distance between them will alter the resulting shadows and depth of the image created. The layers are substantially coplanar, although the visual effect can be changed by subtle alterations in the relative angles of the layers.

The 3D images are created by passing light through the layers. In the preferred embodiment of the invention, light passes from the exterior of the device through the exterior transparent layer, and then through the patterned layer, causing a shadow to be transferred first onto the patterned layer. A second shadow is transferred onto a third opaque layer or backdrop. In this embodiment, the light may be natural, ambient light, or artificially created light.

The visual effect of the pattern can be altered by changing the light, surface texture, and distance between the layers. A multi-dimensional effect can be achieved by which the observer can view the images from all sides that are visible within the device.

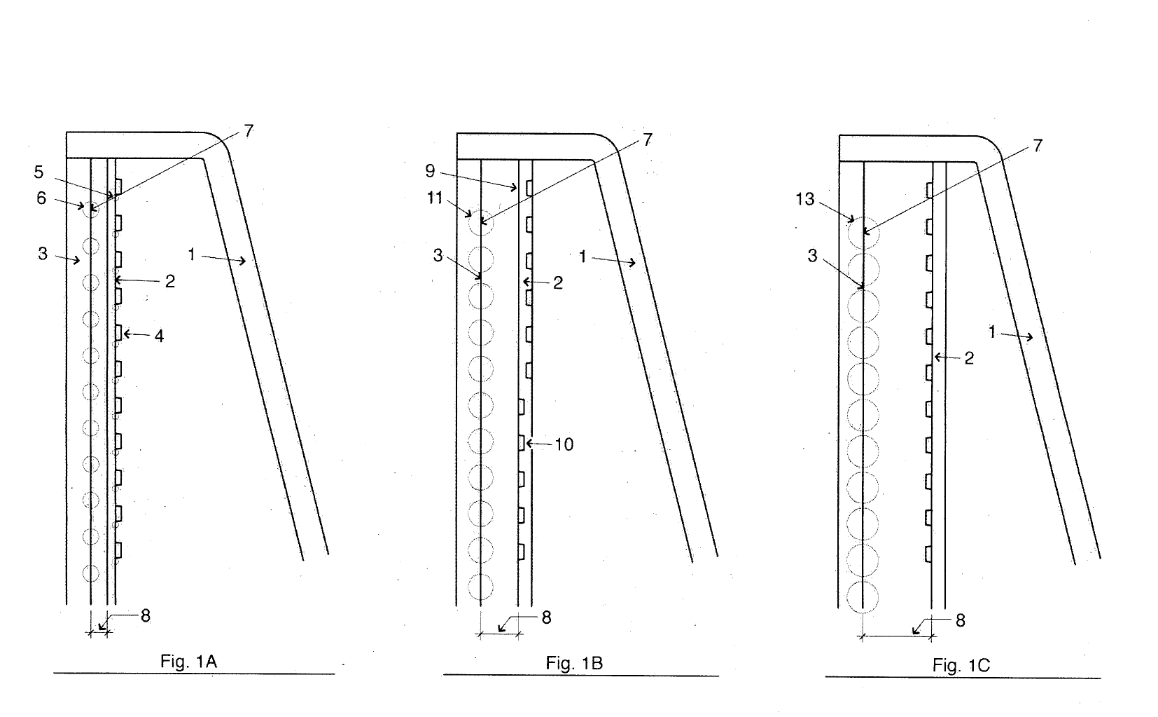

An example of this embodiment is shown in FIG. 1 in three side views. The exterior transparent layer is Part 1, at the right of each diagram. The patterned layer is Part 2. Part 3 is an optional third layer. The layer farthest from the exterior transparent layer is always substantially opaque. All other layers must pass light, and therefore must be substantially transparent or translucent. All of the layers are separated by a hollow cavity.

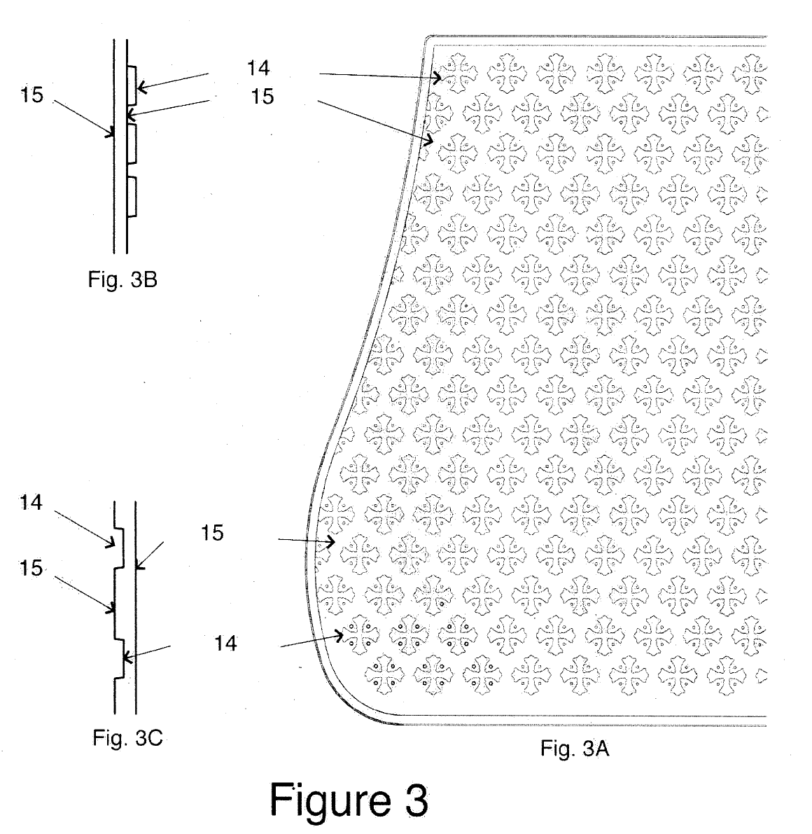

The different views in FIG. 1 demonstrate the effect of changing the angle and distance of separation between the layers. The shadow and depth of the 3D image increases as the pattern layer 2 moves toward the exterior transparent layer 1 and away from the opaque layer or backdrop 3. Conversely, the shadow and depth of the 3D image decreases as the pattern layer moves away from the exterior transparent layer and closer to the opaque layer or backdrop. The pattern can either be external to layer 2, as in 4 and 12, or cut into the layer, as in 9 and 10. Also, the pattern can be either in front of the surface (toward the direction of the light source) or in back of the surface (away from direction of the light source). Ambient light is shown as the lighting source, coming in as per 7. Shadows formed by the pattern are shown (6, 11, 13). They are small (6) when the layers 2 and 3 are close together, as in FIG. 1A; shadow size increases as (11) the layers are moved farther apart (FIG. 3B); shadow sizes increase still more as (13) the layers are moved yet further apart (FIG. 3C).

The orientation of the pattern on the center layer 2 will produce 3D images of varying depth and size. This is illustrated by a comparison of each of the views shown in FIG. 1. In FIG. 1A, the pattern 4 is raised above the surface level of the patterned layer 2 (ie, on the surface facing the exterior transparent layer 1). In FIG. 1C, the raised pattern is on the surface of layer 2 that faces away from the exterior transparent layer 1. In FIG. 1D, the pattern is cut into both the back ((10) and the front (9) of the patterned layer 2, creating a further variation on the visual effect. A pattern can be cut into any of the surfaces of Layers 1, 2, and 3, or any combination of these to create a multi-dimensional effect. The only limitation is that, to obtain the desired 3D effect, a pattern on layer 1, whether raised or sunken, is best located on the back side (away from the incident light 7). The distance between layers is indicated by the dimension 8.

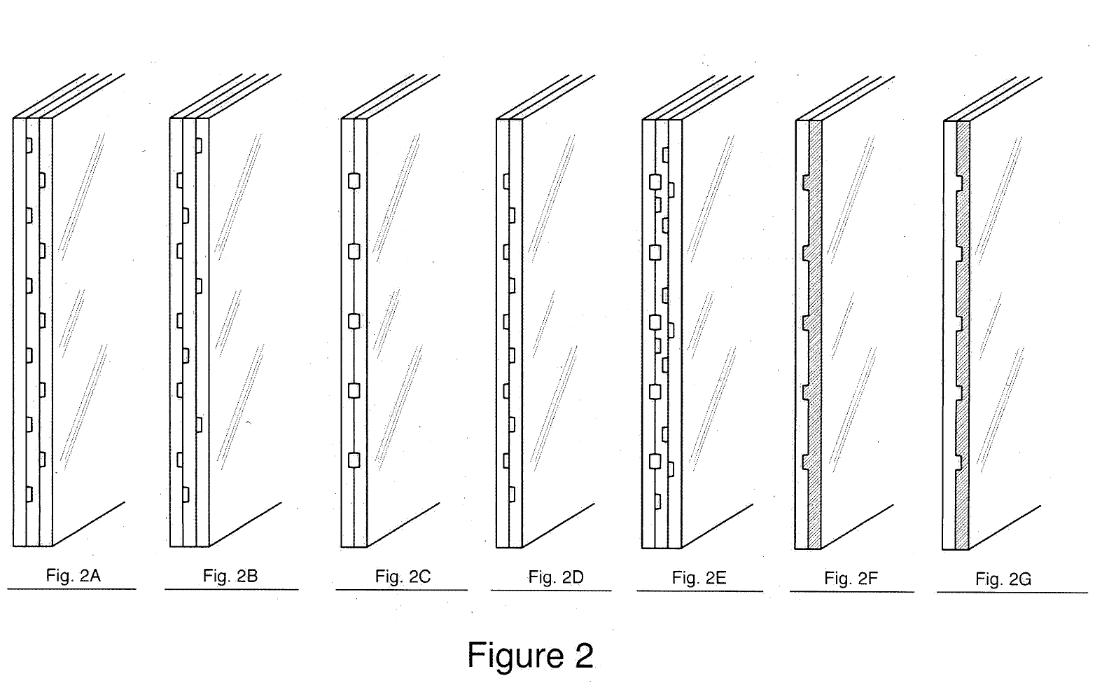

FIG. 2 shows the effect of moving the layers into contact with each other. By closing the distance between layers, a visual 3D pattern can be produced with or without a shadow effect. The plates may be simply placed in juxtaposition, or may be permanently affixed in place, by any means such as gluing, welding, or casting one layer over the next. As few as one patterned plate may be employed, though it must be substantially transparent with a substantially opaque backdrop present. Note, however, that the backdrop need not be incorporated within the device. Thus, any suitable opaque surface such as a wall, a curtain, or the like, will suffice to serve as a backdrop to enhance the performance of the present invention.

Alternatively, FIG. 2 demonstrates that many different patterned plates may be used together to form multidimensional images. The only requirement is that all except the last layer are substantially transparent, while the last layer (or alternatively, a backdrop) is substantially opaque. By “first” and “last” layer, what is meant is the first layer to receive light, and the last layer to receive light. This embodiment of the invention allows for creation of a 3D image by printing a one dimensional pattern on the layers and then placing them together in combination. Note that patterns may be cut into or placed upon the exterior layer.

In FIG. 3, we see a practical application of the present invention, in the form of a lady's fashion purse. The figure shows a partial front view of the patterned layer 2. The pattern may be made by sandblasting a repeating design onto either surface of 2. Side views of the alternative patterns are shown. The sandblasted areas create an opaqueness to the otherwise transparent patterned layer. If layer 2 has a solid color, there will be no depth effect.

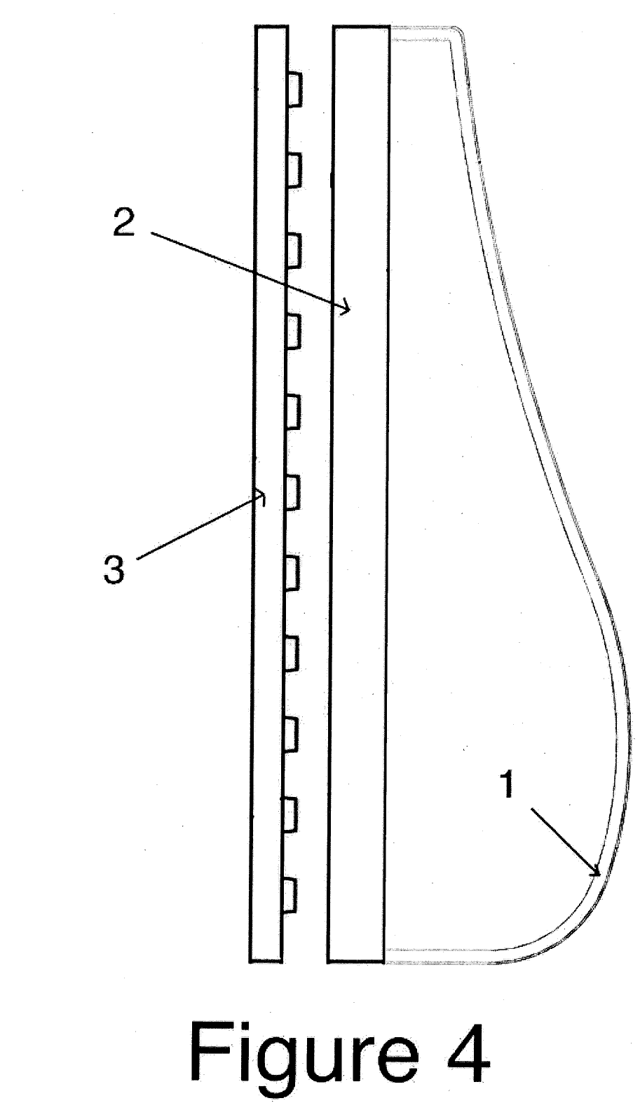

One other aspect of the invention is shown in FIG. 4, again in the form of a lady's fashion purse. In this case, two layers are used in addition to the inner sides of the purse. The inner layer 2 is substantially coplanar with the patterned backdrop 3, which forms the side of the purse. The outer transparent layer 1 is not a flat layer, but is curved relative to the inner layer. This curvature causes the 3D visual image to change from the top to the bottom of the purse, forming an pleasing, undulating visual effect. Again note that the pattern could be placed on or in any of the three layers. Each would create a different visual effect.

Sandblasting is one desirable method for creating a pattern. Note that many other methods of creating patterns are contemplated in this invention. Patterns may be cut, etched, forged, molded, stamped, blown, embossed, engraved, or created by other means. Patterns may be sunken or raised, or even substantially level with the patterned surface. However, raised or sunken patterns are preferred, as they create a more substantial visual effect.

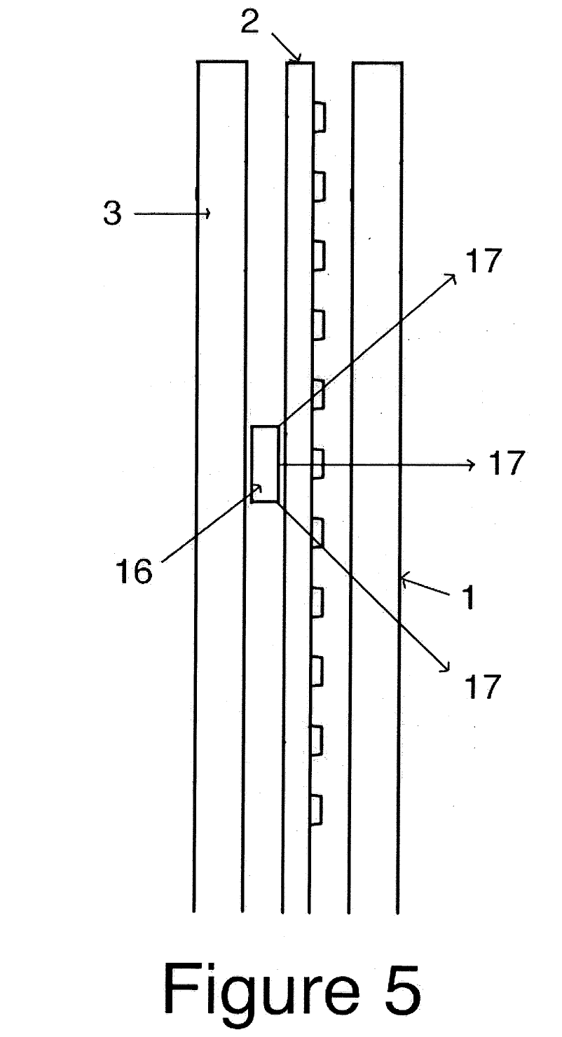

Finally, FIG. 5 shows another alternate embodiment of the invention. In this embodiment, the light is artificially created in the interior of the device at source 16, and shines in the reverse direction 17, from behind the patterned layer 2 to the exterior layer 1. This is the opposite direction from the exterior natural or other light passing first through layer 1 from the outside and then through layer 2, as was portrayed in the previous figures. In FIG. 5, a light is placed between the opaque or backdrop layer 3 and the patterned layer 2. This reverse lighting causes the patterns to stand out more brightly than the rest of the patterned layer, causing a reverse 3D effect.

I claim:

1. A device for creating 3D images, comprising at least one first substantially transparent surface, means for shining light through said first surface; at least one secondary surface, receiving light that has passed through said first surface; at least one of said first or secondary surfaces comprising a pattern of shapes, said shapes being either raised above said surface on either surface side, or sunken into said surface on either surface side.

2. A device according to claim 1 which further comprises a final surface, behind said first and secondary surfaces, said final surface being opaque or reflective of light.

3. A device according to claim 1 wherein all surfaces are substantially coplanar.

4. A device according to claim 1 wherein the means for shining light consists of ambient light.

5. A device according to claim 1 wherein the pattern of shapes is regular.

6. A device according to claim 1 wherein said transparent surfaces are comprised of glass, transparent acrylic, or other transparent plastics.

7. A device according to claim 1 which comprises a container, wherein said first surface is an exterior surface of said container, and said secondary surfaces are interior.

8. A device according to claim 1 which comprises a lady's fashion purse.

9. A device according to claim 1 wherein the first surface is not flat, but curved in shape, thus admitting light at different and varying angles incident to said surface.

10. A device according to claim 1 wherein said first surface is moveable, such that the angle between said first and said secondary surfaces can be changed.

11. A device for creating 3D images, comprising at least one first transparent surface, at least one secondary surface, means for shining light from behind said secondary surfaces toward said first surface; at least one of said first or secondary surfaces comprising a pattern of shapes, said shapes being either raised above said surf ace, or sunken below said surface.
